(19) United States
(12) Patent Application Publication
(10) Pub. No.: US 2018/0025664 A1
(43) Pub. Date: Jan. 25, 2018

(54) COMPUTERIZED METHODS AND SYSTEMS FOR MOTOR SKILL TRAINING

(71) Applicants: Anna CLARKE, Har-Adar (IL); Per - Olof GUTMAN, Haifa (IL)

(72) Inventors: Anna CLARKE, Har-Adar (IL); Per - Olof GUTMAN, Haifa (IL)

(21) Appl. No.: 15/658,548

(22) Filed: Jul. 25, 2017

Related U.S. Application Data
(60) Provisional application No. 62/366,140, filed on Jul. 25, 2016.

(51) Int. Cl. G09B 19/00; G06F 17/18; A63B 69/00; G09B 5/02; G09B 15/00; A63B 69/06; G06F 17/50; G06N 99/00

(52) U.S. Cl. CPC G09B 19/003; G06F 17/5009; G06F 17/18; G06N 99/005; G09B 5/02; G09B 19/0038; G09B 15/00; A63B 69/06; A63B 69/00; A63B 69/004

(57) ABSTRACT

A method of motor skill training using visual computer generated feedback, comprising: receiving from a plurality of sensors measurements of a current position and motion of a trainee's body; constructing an estimated model of the body in the current position and motion based on the measurements and on specific characteristics of the body; calculating a predicted model of the body in an estimated future state based on the estimated model; and presenting the predicted model to the trainee on a visual output device.

### RELATED APPLICATION

This application claims the benefit of priority under 35 USC §119(e) of U.S. Provisional Patent Application No. 62/366,140 filed on Jul. 25, 2016. The contents of the above applications are all incorporated by reference as if fully set forth herein in their entirety.

### FIELD AND BACKGROUND OF THE INVENTION

The present invention, in some embodiments thereof, relates to computer aided motor skill training and, more particularly, but not exclusively, to motor skill training using visual computer generated feedback.

In neural sciences and biomechanics a human mechanism of performing voluntary movements has been described as Feedback Control. The crucial discovery, made by Bernstein in 1929, was that the efferent command signal is stored in the brain for a short time, so that it may be compared with the reafferent signal, i.e. actually performed motion. The learning process is based on comparison of the two signals since any inconsistency triggers a new behavior planned by utilizing additional external and internal information. Human movement control combines two nested control loops: the internal loop gets feedback from proprioceptors, and the external loop gets feedback from exteroceptors. Proprioceptors sense the relative position of neighboring parts of the body and strength of effort being employed in movement. Proprioception together with vestibular and haptic systems produces the overall sense of body position and motion, called kinesthesia. Advanced coaching strategies in sports and dance include training of the kinesthetic sense. Kinesthetic training often requires reducing the level of exteroception: even though visual cues may be very powerful they might produce conflicting feedback. Most responses to kinesthetic feedback are subconscious and occur before we are even aware of the need for adjustment. When we enact a familiar motor task, our body reinforces the established motor programs that are built up by repetition of the same action and form our muscle memory. When we learn a new task our motor learning control loop shapes a new movement pattern. Once it is established for a particular task, consciously controlling it may deteriorate performance. This fact is well known in somatic work and is often addressed as trusting the body's wisdom.

The theory of Motor Learning and Motor Control are fields that attempt to develop theoretical frameworks that may be used to describe human motor learning and control mechanisms and explain observed behaviors. The development of these fields started in 1960s with concepts proposed by Gibson, Bernstein, Fitts, Adams and followed by frameworks developed in 1970s-1980s by Schmidt and Newell. These frameworks became the two dominant theories of motor learning both relevant until this day and supported by experimental evidence: Motor Programs Theory (MPT) and Dynamic Systems Theory (DST), respectively.

According to MPT, human Central Nervous System (CNS) implements a familiar movement pattern best suited for the current activity while continuously adjusting it in a closed loop to respond to the environmental demands. DST takes a very different approach: movement patterns are not chosen by the CNS from a bank of motor programs stored in the brain, but rather emerge naturally as a result of self-organization and interaction with the environment.

Recently, the motor learning and control theoretical research mostly focused on normative modeling: analyzing the precise computational problem that the brain is solving during motor activities, and proposing a mathematical solution that, theoretically, is best for the given task. The vast majority of the computational models in motor learning focused on point-to-point reaching in the presence of some disturbances. In this case, learning between trials is proportional to an error size, as was observed in multiple laboratories and mathematically formalized by state-space models.

The utilization of virtual and augmented reality emerged in fields such as sports, physiotherapy and complex skills acquisition due to an apparent ability of these technologies to provide the user with information. The essential information needed for successful motor learning and rehabilitation is feedback which is a well-established fact in all fields studying human voluntary movement. Some examples are reviewed below:

YouMove is a system that allows the user to repeat a sequence of movements recorded by a coach in front of a full-size augmented reality mirror. The user attempts to match his reflection to the coach's skeleton, appropriately scaled and projected onto the mirror. The feedback is enhanced by audio guidelines and by highlighting the mismatch by red circles overlaid on the user's joints with radius proportional to the joint error. Allowing the user to mimic a recorded coach's moves provides a ‘position command’ for the user's motor control loop.

Virtual reality is extensively used for motor rehabilitation since it is a perfect tool for providing the motivation, as well as task variability and novelty which is vital for successful rehabilitation. Similarly to motor learning by healthy subjects, physiotherapy is largely based on action observation and imitation since recruiting the mirror neuron system is believed to induce positive changes in the activity of the motor system. Virtual reality is often used in combination with robotic rehabilitation systems, such as Locomat. These systems assist the patient in moving limbs in a predefined pattern of the end-effector, update and display the virtual reality environment, and give the feedback of task accomplishment. Patients who use such systems report a significant improvement in their condition, even though these systems do not introduce any conceptual novelty in the rehabilitation process relative to manual physiotherapy, when the therapist moves the patient's limb by hand. The new technology just makes this process more efficient: robotic part allows more durable sessions, more precise and programmable patterns; the VR part provides a better motivation by creating interesting scenarios, and a better assessment of accomplishments.

As a part of the European SKILLS integrated project (2006-2011), virtual reality training platforms for training complex skills were developed and evaluated. The approach to training of these skills was based on decomposition of a complex skill into trainable elements, identifying important sub-skills, and creating a multimodal simulation environment to train them in a VR simulator. The aiding elements discovered during the SKILLS project maybe classified into the three groups: conveying performance feedback, supplying theoretical instruction, and facilitating perception-action embodiment.

### SUMMARY OF THE INVENTION

According to some embodiments of the invention there is provided a According to an aspect of some embodiments of the present invention there is provided a method of motor skill training using visual computer generated feedback, comprising: receiving from a plurality of sensors measurements of a current position and motion of a trainee's body; constructing an estimated model of the body in the current position and motion based on the measurements and on specific characteristics of the body; calculating a predicted model of the body in an estimated future state based on the estimated model; and presenting the predicted model to the trainee on a visual output device.

Optionally, the method further comprises: constructing a goal model of the body in a pre-defined desired position and orientation; and presenting the goal model on the visual output device, to guide the trainee in performing movements so that the predicted model is similar to the goal model.

Optionally, the method further comprises: calculating a motion error between a pre-defined movement task and movement from the estimated model; calculating desired forces and moments from the motion error using control algorithms; calculating a difference between the desired forces and moments and currently estimated forces and moments acting on the trainee's body; constructing a goal model of the body in a desired position from the difference using learning algorithms; and presenting the goal model on the visual output device, to guide the trainee in performing movements so that the predicted model is similar to the goal model.

More optionally, the constructing is done by a state machine of schemes to select an action for creating the goal model.

More optionally, the learning algorithms includes: classifying the difference according to at least one of magnitude, direction and type; selecting one of a plurality of actions based on the classification; creating the goal model from the selected action; and evaluating efficiency of the selected action.

More optionally, the evaluating is done according to a new calculated difference between the desired forces and moments and current forces and moments acting on the trainee's body.

More optionally, the evaluating is done according to a new calculated error between a measured movement and the pre-defined movement task.

More optionally, the selecting is also based on a Q-learning look-up table and the evaluating includes updating the look-up table.

More optionally, the selecting is also based on a guidance strategy for selecting unevaluated actions.

More optionally, the selecting is also based on previously evaluated efficiency of the plurality of actions.

More optionally, the learning algorithms further includes: performing Monte-Carlo simulations of a plurality of suggested action optimizations; selecting one of the plurality of action optimizations based on a cost function calculated on the simulations; and updating the selected action according to the selected action optimization.

More optionally, the learning algorithms further includes: performing Monte-Carlo simulations of a plurality of randomly generated actions; selecting at least one of the randomly generated actions based on a cost function calculated on the simulations; and adding the selected at least one action to the plurality of actions.

More optionally, the method further comprises: presenting on the visual output device recommended movement instructions based on the predicted model, the goal model and the specific characteristics.

More optionally, the method further comprises: evaluating success of the trainee in performing the pre-defined movement task; and activating a second pre-defined movement task based on the success.

More optionally, the method further comprises: detecting failure of the trainee in performing the pre-defined movement task; and activating a default pre-defined movement task.

Optionally, the method further comprises: presenting on the visual output device background elements relative to the predicted model.

Optionally, the trainee is a skydiving trainee.

Optionally, the visual output device is an augmented reality head device.

According to some embodiments of the invention there is provided a computer readable medium comprising computer executable instructions adapted to perform the method of claim 1.

According to an aspect of some embodiments of the present invention there is provided a system of motor skill training using visual computer generated feedback, comprising: a plurality of sensors for acquiring measurements of a current position and motion of a trainee's body; at least one computerized processor for: constructing an estimated model of the body in the current position and motion based on the measurements and on specific characteristics of the body; and calculating a predicted model of the body in an estimated future state based on the estimated model; and a visual output device for presenting the predicted model to the trainee.

According to an aspect of some embodiments of the present invention there is provided a software program product for automatically cross-referencing error information between code developers, comprising: a non-transitory computer readable storage medium; first program instructions for receiving from a plurality of sensors measurements of a current position and motion of a trainee's body; second program instructions for constructing an estimated model of the body in the current position and motion based on the measurements and on specific characteristics of the body; third program instructions for calculating a predicted model of the body in an estimated future state based on the estimated model; and fourth program instructions for presenting the predicted model to the trainee on a visual output device; wherein the first, second, third and fourth program instructions are executed by at least one computerized processor from the non-transitory computer readable storage medium.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention may involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart schematically representing a method for motor skill training using visual computer generated feedback, according to some embodiments of the present invention;

FIG. 2 is a schematic illustration of a system of motor skill training using visual computer generated feedback, according to some embodiments of the present invention;

FIG. 3 is a schematic illustration of a system of skydiver's training, according to some embodiments of the present invention;

FIG. 4 is a schematic illustration of reference coordinate systems and frames, according to some embodiments of the present invention;

FIG. 5A and FIG. 5B are schematic illustrations of a human body biomechanical model, according to some embodiments of the present invention;

FIG. 6 is a schematic illustration of a displayed predicted and desired figures, according to some embodiments of the present invention; and

FIG. 7 is a schematic illustration of a state-machine of a learning module, according to some embodiments of the present invention.

### DESCRIPTION OF SPECIFIC EMBODIMENTS OF THE INVENTION

The present invention, in some embodiments thereof, relates to computer aided motor skill training and, more particularly, but not exclusively, to motor skill training using visual computer generated feedback.

The present invention, referred to as Kinesthetic Training Module (KTM), propose a conceptually new way of training human subjects who are learning new motor skills needed for sports activities and/or new types of motion needed for adaptation to new environments.

According to some embodiments of the present invention, there are provided methods and systems for training motor skill, for example in sports such as skydiving, using computer generated visual models of currently measured, predicted and desired positions of the trainee's body, presented to him during physical practice on a visual output device such as augmented reality goggles.

During a relevant physical activity, measurements are received by a computer from multiple sensors, such as accelerometers, gyroscopes, altimeters and/or GPS, which are attached for example to the trainee's limbs, or from cameras that are installed in the training room and capable of tracking human movements. The computer creates an estimated model of the current position, movement and/or orientations of the trainee's body based on these measurements and other characteristics of the body. The estimated model calculation may be constructed by using an extended Kalman filter (EKF) and may include biomechanical, dynamic and kinematic models, along with models of the interaction between the body and the environment where the specific activity takes place, e.g. aerodynamic models. The computer then calculates the predicted position and/or orientation of the body in the next future, assuming the current motion continues, using EKF. The models are visually presented to the trainee, on top of each other or separately, in real-time, so he may use the feedback and predicted outcome of his movements to correct himself to a desired position.

Optionally, the computer also creates a goal model of a desired position and/or movement, according to predetermined input. Goal models may be computed by on-line learning algorithms converging to a goal model that is most suitable for the specific trainee and task. This way, the trainee may try to perform the correct movements in order to make the predicted and goal models similar. Visual personalized instructions for specific movements may also be presented to the trainee, which are estimated by the computer to be most efficient for achieving the desired position and/or movement.

The present invention may be implemented for learning any kind of motor skill, for example in sports (such as skydiving, rowing, juggling, yoga), dance, music (e.g. playing instruments), martial arts, physiotherapy, work skills (such as surgery and/or industrial assembly) and/or any other motor activity.

As an example, training the skill of controlling the body in free-fall, as in skydiving, is described. This means aiding the body to quickly establish efficient neuromuscular pathways needed for maintaining dynamic stability and maneuvering in free-fall. The system may be used in a free-fall stage of skydiving and assists a novice skydiver to master basic skydiving maneuvers (e.g. moving forward, backwards, sideways in a belly-to-earth position, falling faster and slower, performing controlled turns, transition to back-to-earth position while maintaining stability), or an experienced skydiver to master advanced maneuvers (e.g. maintain a sit-fly, stand-up, head-down position, perform transitions between these postures and controlled moves—forward, backward, sideways, turn, up, down). After a learning stage (different for each individual) the body develops muscle memory and the skydiver is able to perform the learnt maneuvers automatically (without thinking) and without the system.

The reason for the choice of this example is that mastering body flight requires a completely new skill-set, contradicts existing body reflexes, involves multiple physiological challenges and, therefore, more than other sports, it suffers from imperfections of the human kinesthetic mechanism. Consequently, the process of learning how to move in a free-fall environment is of great scientific interest, while no systematic research of this activity has been conducted to date.

The state-of-the-art training methods of free-fall maneuvers are being developed by AXIS Flight School and continuously published in the Foundations of Flight section of the Parachutist Magazine. These methods concentrate on detailed descriptions of empirically established body postures that are required for performing various free-fall maneuvers. No systematic study or scientific research has ever been conducted on the functionality of the human kinesthetic loop in free-fall, and the effect of different training techniques on its performance. Moreover, all training techniques hitherto practiced are off-line: watching the video recording of the jump, practicing the desired body position on the ground, and visualizing the future maneuvers. The only exception is training in a wind tunnel, where skydiving may be simulated closely enough in real time. The tunnel solves the problem of an overwhelming exteroception and stress, but the rest of the learning difficulties stay unresolved. The student's skills improve only after a very long time spent in the tunnel or in free-fall. The need for a conceptually new training method is becoming apparent: skydiving operations are rapidly growing, along with the number of fatalities which are all, nowadays, due to human errors (none due to a total equipment failure). The proposed training tool accelerates learning of free-fall maneuvers, thus preventing free-fall collisions (responsible for about 10% of all skydiving fatalities) caused by lack of control experienced by novice skydivers.

Aerodynamics of a human body in free-fall is a relatively unresearched area. The closest problem to a skydiver motion in free-fall is aircraft stability and control analysis. There is a vast knowledge base for aircraft stability derivatives, flow field, maneuvers, and bifurcations. However, there is nothing comparable for the free-fall parachutist. The reason is that free-fall maneuvers may be very complex, the parachutist does not behave as a rigid body, nonlinear simulation of the parachutist dynamics becomes impractical due to the unreasonably large amount of computational time required to generate Computational Fluid Dynamics (CFD) data over a required range of body poses. Thus, the few existing works on simulation and analysis of skydiving focus on small perturbation linearized dynamics about a basic free-fall pose assuming the body is rigid. Providing online solutions during unstable transitions and high amplitude maneuvers seems to be extremely challenging. A general skydiver's model, as well as online aerodynamic coefficients estimation is also proposed hereafter.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

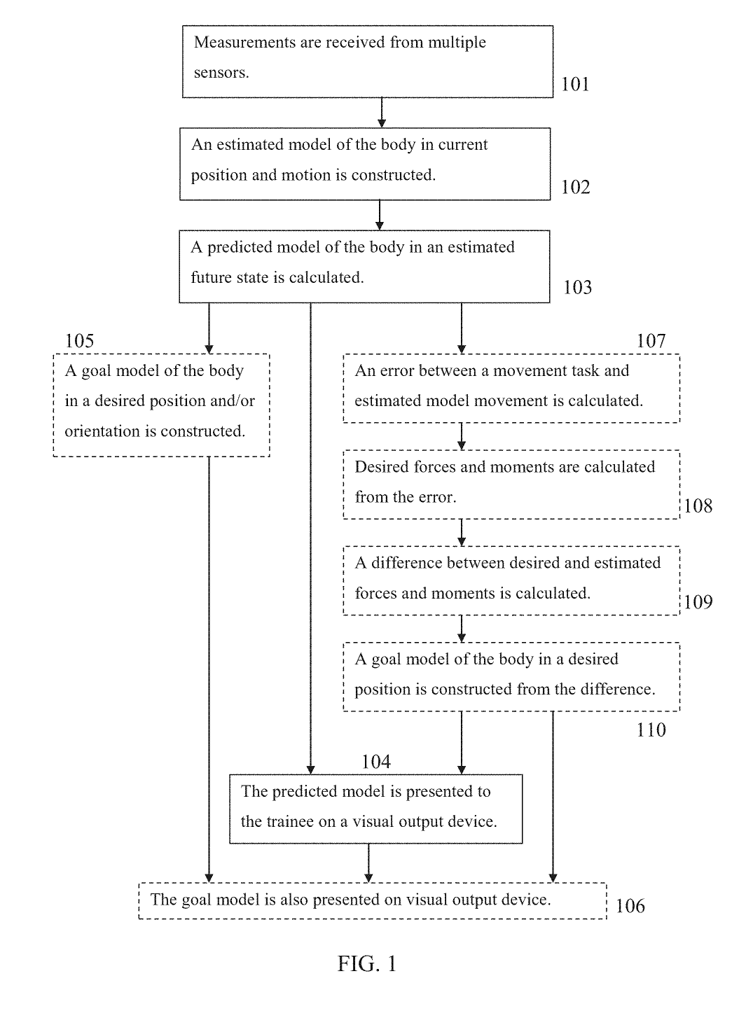

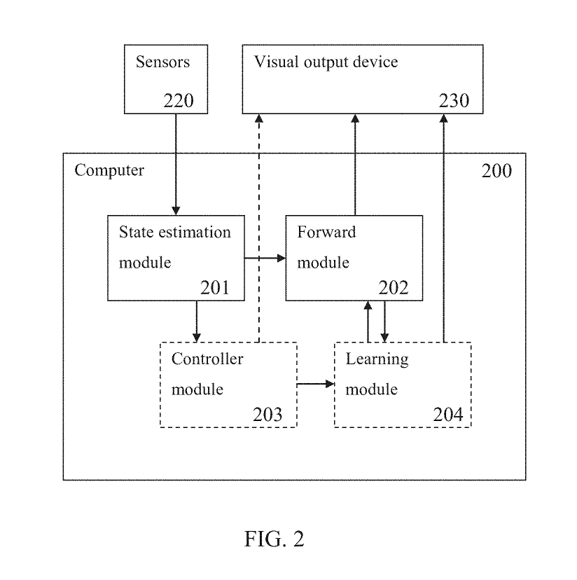

Referring now to the drawings, FIG. 1 is a flowchart schematically representing a method for motor skill training using visual computer generated feedback, according to some embodiments of the present invention. Reference is also made to FIG. 2, which is a schematic illustration of a system of motor skill training using visual computer generated feedback, according to some embodiments of the present invention.

The system includes a computer 200, which may include, for example, a personal computer, a workstation, a mobile device such as a Smartphone, a tablet, a wearable device such as Google glass, a Smart watch, a laptop computer and/or the like, and/or any computing device. For skydiving, computer 200 is preferably a wearable computer, a micro-computer and/or any other highly portable device.

First, as shown at 101, measurements of a current position and motion of a trainee's body are received from multiple sensors 120.

Sensors 120 may include, for example, accelerometers, gyroscopes, magnetometers, shape tapes, speedometers, pressure sensors, cameras, motion detectors, altimeters, inertial measurement units (IMUs), global positioning system (GPS) devices and/or any other measurement device. Sensors 120 may be attached to the trainee's body, or may be positioned to track the body externally, for example cameras that are installed in a training room. For the example of skydiving, the sensors may include limbs sensors (3D accelerometers, 3D gyroscopes, and optionally 3D magnetometers and/or shape tape) which are attached to each significant limb (measuring, for example, at a rate of 100 Hz or more) and an altimeter and/or a GPS device (which may perform measurements at a lower rate).

Then, as shown at 102, an estimated model of the body in said current position and motion is constructed based on the measurements and on specific characteristics of the body. This is done by a state estimation module 201 of computer 200.

The specific characteristics may include, for example, personal parameters of the trainee's body (such as height, weight, limbs length and/or movement range), physiological parameters (such as heart rate, resting pulse and/or sugar levels), current environmental parameters (weather, temperature and/or terrain) and/or any other information. The specific characteristics may be measured by the system, for example via sensors 120, and/or may be manually or automatically inputted to the system.

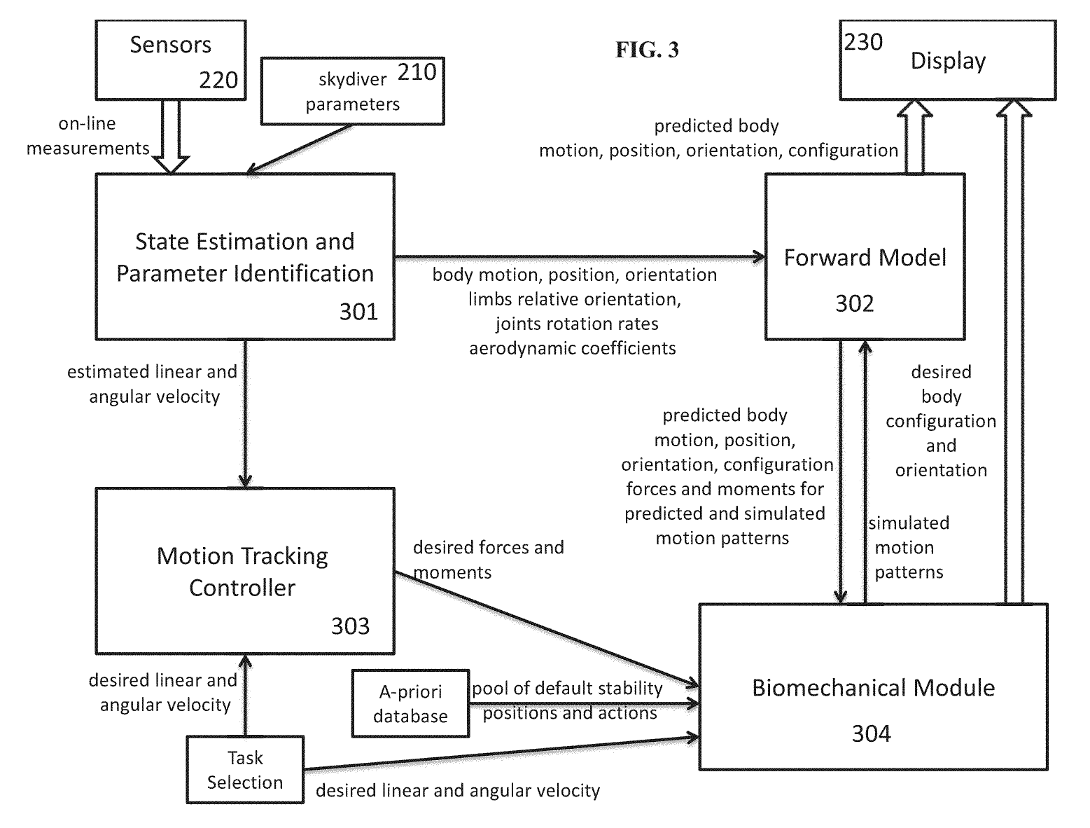

Reference is now made to FIG. 3, which is a schematic illustration of a system of skydiver's training, according to some embodiments of the present invention.

In the example of skydiving, the specific characteristics may include constant skydiver's parameters (310), such as weight, size, jumpsuit type and/or body segment data, which may be inputted to the system prior to training. These are used by the state estimation and parameter identification module (301), in combination with sensors measurements (320), to estimate the following states: skydiver's inertial motion (linear and angular velocity), position and orientation; skydiver's configuration (relative body limbs orientation) and joints rotation rates; and aerodynamic dimensionless coefficients derivatives with respect to angles of attack and sideslip (lift, drag, and moments of each limb).

The estimation process may be formulated as an Extended Kalman Filter (EKF), for example when raw measurements are received from sensors 120. To decrease the amount of states (due to computational time considerations), it is possible to split this EKF into two separate filters (EKFs): the first one concerned only with skydiver's configuration, and the second one with inertial motion and aerodynamics. The second EKF therefore receives (and treats as parameters) the outputs of the first EKF: relative body limbs orientation and joints rotation rates. These outputs may be used to calculate the skydiver's instantaneous center-of-gravity position, inertia tensor, and their derivatives in order to further simplify the second filter (by formulating the equations of motion for a single body with continuously changing center-of-gravity and inertia tensor).

The EKFs model includes the following sub-models: biomechanical model, dynamic equations of motion, kinematic model and aerodynamic model.

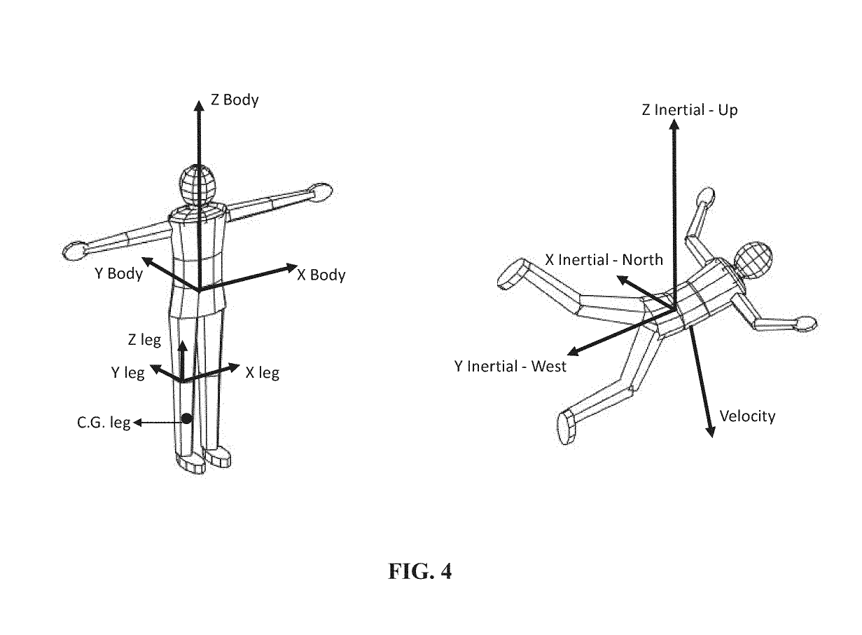

The equations of motion stated below are derived with respect to reference coordinate systems and frames, as shown at FIG. 4. The coordinate systems include: Inertial frame (north, west, up), Body frame, Wind frame (transformation from Body to Wind frame includes two Euler rotations a about X-axis, and then −β about Y-axis), Limb local frame and Local wind frame (transformation from Local limb to Wind frame defines local angle of attack, sideslip, and roll).

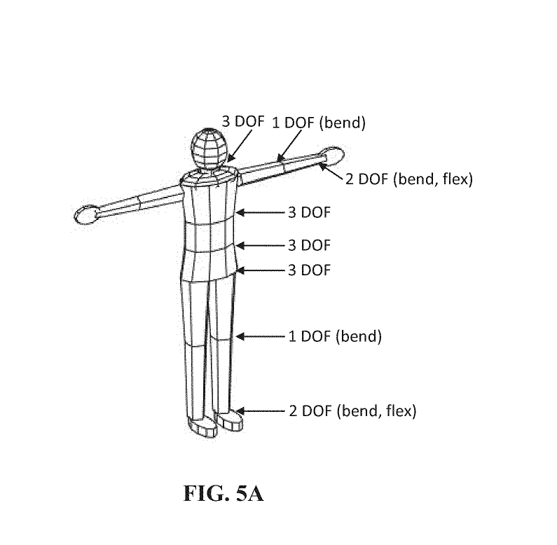

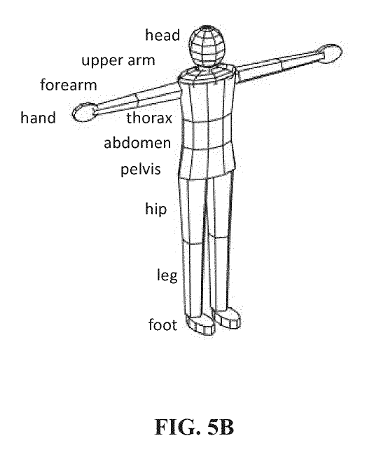

1. Biomechanical Model—This model formulates the configuration of the human body and its feasible movements. Reference is now made to FIG. 5A and FIG. 5B, which are schematic illustrations of a human body biomechanical model, according to some embodiments of the present invention. For the purpose of modeling a skydiver, a body may be approximated by 15 rigid linked segments with 30 degrees-of-freedom (DoF), as shown on FIG. 4: head, thorax+abdomen, pelvis, upper arms, forearms, hands, thighs, legs, feet. When more accurate modeling is desired (when advanced skydiving maneuvers are considered), the thorax and abdomen may be modeled as separate segments with additional three degrees of rotational freedom between them, producing thus a 16-segment model with 33 DoF, as shown on FIGS. 5A-B. For convenient center-of-gravity (CoG) and inertia computations the segments may be modeled as simple geometrical shapes: ellipsoid (head), truncated elliptical cones (thorax, abdomen, pelvis), truncated cones (upper arms, forearms, thighs, legs), elliptical cylinders (hands, feet). Segments properties (length, mass, volume) may be extracted from the existing Body Segment Data (BSD) databases and adjusted to a particular skydiver (specifying weight, height, body type). When modeling (predicting and updating) a limb movement, feasibility constraints must be enforced: consistency with the range of motion of each joint and collision avoidance between limbs.

Body Segments Parameters (BSP) Equations—The following data is computed for each segment i:
Principal Moments of Inertia (Ixxᵢ, Iyyᵢ, Izzᵢ)_{local}
center of gravity (in local coordinates) \vec{R}_{cg}_{ᵢ}local
origin of local coordinates relative to the parent segment it is attached \vec{D}_{Child Limb}_{_{IN Parent Limb}}
transformation between child and parent segments, defined by Euler angles and interpreted as a rotation quaternion d_{Child Limb}^{Parent Limb}

Transformation Chain—Computing origin, center of gravity, and transformation of Local Limb i frame relative to Body Frame:
D_{Limb}_{_{iIN Body}}, R_{cg}_{_{iBody}}, q_{Body}^{Limb}^{ᵢ}

For example, for the right hand:

$${q}_{Body}^{Right Hand} = {\underbrace{{( {q}_{Right Forearm}^{Right Upperarm} )}^{*}}}_{2 DOF} ⊗ {\underbrace{{( {q}_{Right Forearm}^{Right Upperarm} )}^{*}}}_{1 DOF} ⊗ {\underbrace{{( {q}_{Right Upperarm}^{Thorax} )}^{*}}}_{3 DOF} ⊗ {\underbrace{{( {q}_{Thorax}^{Abdomen} )}^{*}}}_{3 DOF} ⊗ {\underbrace{{( {q}_{Abdomen}^{Body} )}^{*}}}_{3 DOF}$$

$${\vec{D}}_{Right {Hand}_{IN Body}} = {( {q}_{Abdomen}^{Body} )}^{*} ⊗ ( {\vec{D}}_{{Thorax}_{IN Abdomen}} + {( {q}_{Thorax}^{Abdomen} )}^{*} ⊗ ( {\vec{D}}_{Right {Upperarm}_{IN Thorax}} + {( {q}_{Right Upperarm}^{Thorax} )}^{*} ⊗ ( {\vec{D}}_{Right {Forearm}_{IN Right Upperarm}} + {( {q}_{Right Forearm}^{Right Upperarm} )}^{*} ⊗ {\vec{D}}_{Right {Hand}_{IN Right Forearm}} ) ) )$$

$${\vec{R}}_{{cg}_{Right {Hand}_{Body}}} = {\vec{D}}_{Right {Hand}_{IN Right Body}} + {q}_{Body}^{Right Hand} ⊗ {\vec{R}}_{{cg}_{Right {Hand}_{local}}}$$

Summary: Body CoG and Inertia Tensor:

$${\vec{R}}_{cg} = \frac{{\sum }_{i = 1}^{{N}_{Limbs}} {\vec{R}}_{{cg}_{{i}_{Body} }} {m}_{i}}{{\sum }_{i = 1}^{{N}_{Limbs}} {m}_{i}}$$

$$I = {\sum }_{i = 1}^{{N}_{Limbs}} ( {DCM}_{Body}^{{Limb}_{i}} {{I}_{{local}_{i}} ( {DCM}_{Body}^{{Limb}_{i}} )}^{T} + {[ \begin{matrix}Δ {Y}^{2} + Δ {Z}^{2} & - Δ X Δ Y & - Δ X Δ Z \\ - Δ X Δ Y & Δ {X}^{2} + Δ {Z}^{2} & - Δ Y Δ Z \\ - Δ X Δ Z & - Δ Y Δ Z & Δ {X}^{2} + Δ {Y}^{2}\end{matrix} ]}_{i} {m}_{i} )$$

where mᵢ—mass of Limb i, DCM_{Body}^{Limb}^{ᵢ}—Direction Cosine Matrix, computed from quaternion q_{body}^{Limb}^{ᵢ}, and

$${[ \begin{matrix}Δ X \\ Δ Y \\ Δ Z\end{matrix} ]}_{i} = [ \begin{matrix}{X}_{{cg}_{i}} - {X}_{cg} \\ {Y}_{{cg}_{i}} - {Y}_{cg} \\ {Z}_{{cg}_{i}} - {Z}_{cg}\end{matrix} ]$$

2. Dynamic Equations of Motion—Equations of motion express the fact that the derivative of linear momentum of the body is equal to the sum of forces acting on it, and the derivative of angular momentum—to the sum of moments. Equations of motion for a multibody system (composed of rigid segments) may be formulated using Newton-Euler, Lagrange, or Kane methods. The forces acting on the body of a skydiver in free-fall are the gravity and aerodynamic forces (lift and drag). The orientation of the body relative to the inertial world and the limbs' relative orientations are most conveniently expressed by quaternions (however, Euler angles, Rodriguez parameters, etc, may also be used).

The equations of motion for the general case (without neglecting any terms) are highly non-linear. Therefore, in order to reduce the computations complexity, the motion equations may be approximated by linearization about an equilibrium state, when the system is operating in the proximity to one of its equilibrium states. When, on the contrary, the system is transitioning between its equilibrium states while performing large-scale maneuvers, the full non-linear equations must be used at the prediction step, and iterations may be advantageous during the update step (as in IEKF—Iterated Extended Kalman Filter).

Forces

$${F}^{->} = [ \begin{matrix}X \\ Y \\ Z\end{matrix} ]$$

are obtained from linear momentum derivative:

$${p}^{->} = m {V}^{->} + m {Ω}^{->} \vec{{r}_{cg}}$$

$${F}^{->} = \frac{d {p}^{->}}{dt} + {Ω}^{->} {p}^{->}$$

$${F}^{->} = m {V}^{\dot{->}} + m {Ω}^{\dot{->}} \vec{{r}_{cg}} + m {Ω}^{->} \dot{\vec{{r}_{cg}}} + {Ω}^{->} ( m {V}^{->} + m {Ω}^{->} \vec{{r}_{cg}} )$$

$$where {V}^{->} = [ \begin{matrix}U \\ V \\ W\end{matrix} ] - linear velocity , {Ω}^{->} = [ \begin{matrix}P \\ Q \\ R\end{matrix} ] - angular velocity .$$

Forces Summary:

$$\frac{1}{m} [ \begin{matrix}X \\ Y \\ Z\end{matrix} ] = [ \begin{matrix}\dot{U} \\ \dot{V} \\ \dot{W}\end{matrix} ] + [ \begin{matrix}\dot{Q} {z}_{cg} - \dot{R} {y}_{cg} \\ \dot{R} {x}_{cg} - \dot{P} {z}_{cg} \\ \dot{P} {y}_{cg} - \dot{Q} {x}_{cg}\end{matrix} ] + [ \begin{matrix}Q \dot{{z}_{cg}} - R \dot{{y}_{cg}} \\ R \dot{{x}_{cg}} - P \dot{{z}_{cg}} \\ P \dot{{y}_{cg}} - Q \dot{{x}_{cg}}\end{matrix} ] + [ \begin{matrix}QW - RV \\ RU - PW \\ PV - QU\end{matrix} ] + [ \begin{matrix}Q ( {Py}_{cg} - {Qx}_{cg} ) - R ( {Rx}_{cg} - {Pz}_{cg} ) \\ R ( {Qz}_{cg} - {Py}_{cg} ) - P ( {Py}_{cg} - {Qx}_{cg} ) \\ P ( {Rx}_{cg} - {Pz}_{cg} ) - Q ( {Qz}_{cg} - {Ry}_{cg} )\end{matrix} ]$$

Moments

$${M}^{->} = [ \begin{matrix}L \\ M \\ N\end{matrix} ]$$

are obtained from angular momentum derivative:

$${L}^{->} = I {Ω}^{->} + m \vec{{r}_{cg}} {V}^{->}$$

$${M}^{->} = \frac{d {L}^{->}}{dt} + {Ω}^{->} {L}^{->} + {V}^{->} ( m {Ω}^{->} \vec{{r}_{cg}} )$$

$${M}^{->} = I {Ω}^{\dot{->}} + \dot{I} {Ω}^{->} + \vec{{r}_{cg}} m {V}^{\dot{->}} + \dot{\vec{{r}_{cg}}} m {V}^{->} + {V}^{->} ( m {Ω}^{->} \vec{{r}_{cg}} ) + {Ω}^{->} ( I {Ω}^{->} ) + {Ω}^{->} ( \vec{{r}_{cg}} m {V}^{->} )$$

$$where I = [ \begin{matrix}{I}_{xx} & {I}_{xy} & {I}_{xz} \\ {I}_{yx} & {I}_{yy} & {I}_{yz} \\ {I}_{zx} & {I}_{zy} & {I}_{zz}\end{matrix} ] - inertia tensor .$$

Moments Summary:

L=I_{\dot{x}x}P−I_{\dot{x}y}Q−I_{\dot{x}z}R+Iₓₓ\dot{P}−I_{xy}(\dot{Q}−RP)−I_{xz}(\dot{R}+PQ)−I_{yz}(Q²−R²)+(I_{zz}−I_{yy})QR+my_{ċg}W−mz_{ċg}V+my_{cg}(\dot{W}+VP−QU)+mz_{cg}(−\dot{V}+WP−RU)

M=I_{\dot{y}y}Q−I_{\dot{y}x}P−I_{\dot{y}z}R+I_{yy}\dot{Q}−I_{xy}(\dot{P}+QR)−I_{yz}(\dot{R}−PQ)−I_{xz}(R²−P²)+(Iₓₓ−I_{zz})PR+mz_{ċg}U−mx_{ċg}W+mx_{cg}(−\dot{W}+QU−PV)+mz_{cg}(\dot{U}+WQ−RV)

N=I_{żz}R−I_{\dot{x}z}P−I_{\dot{y}z}Q+I_{zz}\dot{R}+I_{xz}(−\dot{P}+QR)−I_{yz}(\dot{Q}+PR)+I_{xy}(Q²−P²)+(I_{yy}−Iₓₓ)PQ+mx_{ċg}V−my_{ċg}U+mx_{cg}(\dot{V}+UR−PW)+my_{cg}(−\dot{U}+VR−QW)

Forces and Moments Acting on the Body:

$${F}^{->} = {\sum }_{i = 1}^{{N}_{limbs}} {\vec{{F}_{a}}}^{i} + {q}_{Body}^{I} ⊗ [ \begin{matrix}0 \\ 0 \\ - m g\end{matrix} ]$$

$${M}^{->} = {\sum }_{i = 1}^{{N}_{segments}} ( \vec{{r}_{cg}^{l}} {\vec{{F}_{a}}}^{i} + {\vec{{M}_{a}}}^{i} ) + \vec{{r}_{cg}} ( {q}_{Body}^{I} ⊗ [ \begin{matrix}0 \\ 0 \\ - m g\end{matrix} ] )$$

where \vec{Fₐ}ⁱ, \vec{Mₐ}ⁱ, \vec{r_{cg}ⁱ}—aerodynamic force and moment acting on body limb i and its center of gravity expressed in Body coordinates, q_{body}^{I}—rotation quaternion from Inertial to Body frame, updated as follows:

$${\dot{q}}_{Body}^{I} = 0.5 [ \begin{matrix}0 & - P & - Q & - R \\ P & 0 & R & - Q \\ Q & - R & 0 & P \\ R & Q & - P & 0\end{matrix} ] {q}_{Body}^{I}$$

3. Kinematic Model—The following kinematic computations are required:

Equations linking the rotational rates in body coordinate system (attached to the pelvis) to derivatives of the angles describing inertial orientation;

Calculating the local angle of attack and sideslip of each body segment (from the velocity vector expressed in body coordinate system and the orientation of the segment relative to body system, which depends on joint angles along the chain from the limb to pelvis—origin of the body system); and

Joint's kinematic constraints: at each computation step after estimating the motion of each body segment separately from the sensors attached to it, the linked configuration of the body must be enforced, according to its definition formulated in the Biomechanical Model.

Computing Inertial Orientation [ψ θ φ] from

$${q}_{Body}^{I} = [ \begin{matrix}{q}_{0} \\ {q}_{1} \\ {q}_{2} \\ {q}_{3}\end{matrix} ] \text{:}$$

$$ψ = atan \frac{2 ( {q}_{0} {q}_{3} + {q}_{1} {q}_{2} )}{1 - 2 ( {q}_{2}^{2} + {q}_{3}^{2} )}$$

$$θ = asin 2 ( {q}_{0} {q}_{2} - {q}_{1} {q}_{3} )$$

$$φ = atan \frac{2 ( {q}_{0} {q}_{1} + {q}_{3} {q}_{2} )}{1 - 2 ( {q}_{2}^{2} + {q}_{1}^{2} )}$$

Computing Body Angles of Attack α and Sideslip β:

$$α = - atan \frac{V}{W}$$

$$β = - asin \frac{U}{sqrt ( {U}^{2} + {V}^{2} + {W}^{2} )}$$

Computing Rotation Quaternion from Body to Wind Frame:

$${q}_{Wind}^{Body} = [ \begin{matrix}cos \frac{α}{2} \\ sin \frac{α}{2} \\ 0 \\ 0\end{matrix} ] ⊗ [ \begin{matrix}cos \frac{- β}{2} \\ 0 \\ sin \frac{- β}{2} \\ 0\end{matrix} ]$$

Computing Rotation Quaternion from Local Limb i to Wind Frame and Local Angles of Attack, Sideslip, and Roll:

$${q}_{Wind}^{{Limb}_{i}} = {q}_{Body}^{{Limb}_{i}} ⊗ {q}_{Wind}^{Body} = {[ \begin{matrix}{q}_{0} & {q}_{1} & {q}_{2} & {q}_{3}\end{matrix} ]}^{T}$$

$${α}_{i} = atan \frac{2 ( {q}_{0} {q}_{3} - {q}_{1} {q}_{2} )}{{q}_{0}^{2} - {q}_{1}^{2} - {q}_{2}^{2} + {q}_{3}^{2}}$$

$${β}_{i} = - asin 2 ( {q}_{0} {q}_{2} + {q}_{1} {q}_{3} )$$

$${γ}_{i} = atan \frac{2 ( {q}_{0} {q}_{3} - {q}_{1} {q}_{2} )}{{q}_{0}^{2} - {q}_{2}^{2} - {q}_{3}^{2} + {q}_{1}^{2}}$$

4. Aerodynamic model—formulates the aerodynamic forces and moments acting on a skydiver in free-fall without solving the flow field around its body (which would be impossible in real-time). One of the efficient ways (computationally feasible and sufficient for the current application) to model the aerodynamic forces and moments may be following the guidelines below:
The resulting aerodynamic force/moment may be computed as a sum of forces/moments acting on each body's limb.
Forces and moments acting on a limb are proportional to the square of the local velocities in tangential and normal directions, air density, the cross sectional area in tangential and normal directions, and the aerodynamic coefficients
The aerodynamic coefficients (lift, drag, moments) depend on the local angles of attack and sideslip (calculated by the kinematic model) and the coefficients' derivatives with respect to these angles (which are part of the EKF state).
Initial values for the coefficients' derivatives with respect to angles of attack and sideslip may be taken from look-up tables constructed off-line from available data (CFD results, wind tunnel experiments) for different types of jumpsuits.
The model scales the calculated forces/moments acting on a limb to the extent this limb is exposed to the relative wind (as it may become blocked by other body parts).

Calculating Forces:

Aerodynamic force acting on Limb i consists of two components: Lᵢ perpendicular and Dᵢ parallel to the local wind direction:

$${L}_{i} = {( {q}_{Wind}^{Body} )}^{*} ⊗ ( [ \begin{matrix}cos \frac{{γ}_{i}}{2} \\ 0 \\ 0 \\ sin \frac{{γ}_{i}}{2}\end{matrix} ] ⊗ [ \begin{matrix}0.5 ρ {A}_{i} {‖ {V}^{->} ‖}^{2} {( {Cl}_{β} )}_{i} \\ 0.5 ρ {A}_{i} {‖ {V}^{->} ‖}^{2} {( {Cl}_{α} )}_{i} \\ 0\end{matrix} ] )$$

where Aᵢ—limb characteristic area (local xz plane), ρ—air density, (Clₐ)ᵢand(Cl_{β})ᵢ—aerodynamic coefficients:

(Cl_{α})ᵢ=(Cl_{α})ᵢ^{max} sin(2αᵢ)

(Cl_{β})ᵢ=(Cl_{β})ᵢ^{max} sin(2βᵢ)

where (Cl_{α})ᵢ^{max}, (Cl_{β})ᵢ^{max} are assumed to be known parameters.

Aerodynamic Model: Forces

$${D}_{i} = {( {q}_{Wind}^{Body} )}^{*} ⊗ [ \begin{matrix}0 \\ 0 \\ 0.5 ρ {Area}_{i} {‖ {V}^{->} ‖}^{2} {Cd}_{i}^{max}\end{matrix} ]$$

where Areaᵢ—Limb area exposed to the air flow, for belly-to-earth pose may be approximated as:

max(Aᵢ^{xz}| cos βᵢ sin αᵢ|, Aᵢ^{xy}| cos βᵢ cos αᵢ|, Aᵢ^{yz}| sin βᵢ|) and Cdᵢ^{max} is assumed to be a known parameter.

Calculating Moments:

Aerodynamic moment acting on a body segment which is angled relative to the air flow may be approximated as follows:

$${M}_{i} = {( {q}_{Wind}^{Body} )}^{*} ⊗ ( [ \begin{matrix}cos \frac{{γ}_{i}}{2} \\ 0 \\ 0 \\ sin \frac{{γ}_{i}}{2}\end{matrix} ] ⊗ [ \begin{matrix}0.5 ρ {A}_{i} {‖ {V}^{->} ‖}^{2} {{Length}_{i} ( {Cm}_{α} )}_{i} \\ 0.5 ρ {A}_{i} {‖ {V}^{->} ‖}^{2} {{Length}_{i} ( {Cm}_{β} )}_{i} \\ 0\end{matrix} ] )$$

where Lengthᵢ is limb characteristic length, (Cm_{α})ᵢ and (Cm_{β})ᵢ are aerodynamic coefficients:

(Cm_{α})ᵢ=−(Cm_{α})ᵢ^{max} sin(2αᵢ)

(Cm_{β})ᵢ=−(Cm_{β})ᵢ^{max} sin(2βᵢ)

where (Cm_{α})ᵢ^{max}, (Cm_{β})ᵢ^{max} are assumed to be known parameters.

After the moments of all limbs are summarized a small damping moment is added (This moment occurs due to the changes in the orientation of the local wind vector with rotation rates across the parachutist):

\vec{M}_{damp}=−0.5ρA∥\vec{V}∥²Height\vec{Cm}_{damp}\vec{Ω}

where A—overall area exposed to the airflow, Height—skydiver's height, \vec{Cm}_{damp} damping coefficients assumed to be known, \vec{Ω}—Body angular velocity.

Then, as shown at 103, a predicted model of the body in an estimated future state is calculated based on the estimated model. This is done by a forward module 202 of computer 200, which solves the dynamic equations of motion forward in time starting from the initial state estimated by state estimation module 201 (body configuration, joints rotation rates, body inertial position, orientation, velocity).

In the example of skydiving, the estimated aerodynamic coefficients are used in the forward model (302) as parameters. The prediction time conveys the reaction time of the skydiver, and may be individually tuned on-line, for example, common values may be in the interval of 200-1000 msec.

The predicted model may have a standard EKF formulation, as described above, using the estimated model as input. The prediction step uses the above equations of motion after linearization, and the update step uses the measurement equations (expressing the relation between the measurements supplied by the sensors and the states of the EKF). For example, rotational rates and accelerations measured by IMU and position measured by GPS are usually a part of the state vector, so the measurement equations are straightforward.

Optionally, when both the estimated model and the predicted model are formulated by EKF, the two EKFs are joined into one EKF with an extended state.

Then, as shown at 104, the predicted model is presented to the trainee on a visual output device 230 (or display 330).

Visual output device 230 may include, for example, a screen, a projector, a virtual or augmented reality goggles or helmet and/or any other device having computer input and visual output. Visual output device 230 may also be combined with computer 200, for example in a mobile device such as a smartphone, Google glass and/or self contained virtual or augmented reality helmet.

The presentation may include a computer generated human figure, according to the predicted model, presented for example in front of the trainee and viewed from behind and slightly above. The presentation may also include a second human figure, according to the estimated model, which may be presented on top of the first figure or separately. One or more of the presented figures may be colored differently and/or may be semi-transparent.

Optionally, background elements relative to the presented models are also displayed on visual output device 230. Forward module 202 also calculates position and orientation relative to the previous frame (previous display time) of the background elements. The background elements may include, for example, a 3D grid, a pattern of 3D dots and/or a set of clouds randomly distributed around a virtual skydiver figure. The background elements convey the current and/or predicted linear and angular velocity of a skydiver.

The solution for all states during the prediction-time period is the output for the augmented display: the predicted body configuration and inertial orientation is used to draw the first skydiver's figure and the linear and angular velocities are used to compute translation and rotation matrixes for moving the background objects. This way a skydiver gets a clear cue about his predicted motion while his predicted figure always stays in the middle of the display. The predicted figure should be viewed from slightly above and behind, however the default viewing angles may be adjusted on-line, such that the major differences between the predicted and the desired configurations are easily perceived. The display should be stabilized using the inertial orientation and angular velocity of the head.

Optionally, as shown at 105, a goal model of the body in a desired position and/or orientation is constructed, and, as shown at 106, is also presented on visual output device 230, to guide the trainee in performing movements so that the predicted model is similar to the goal model. This may be done for activities that have static pre-defined goal positions, such as in yoga, so moving the body into one of those positions is the whole and only task of the activity.

Optionally, as shown at 107-110, a goal model of the body in a desired position and/or orientation is constructed based on a pre-defined movement task. In dynamic activities, such as skydiving, the task is dynamic: to slow down, to turn, to keep balance, to roll over, etc. There exist multiple possible sequences of body poses that will result in completing the task (due to the human kinematic redundancy). The aim is to suggest to the trainee at each instant of time such a goal position that will be most effective for the task and most easily executed by the trainee, considering his particular body parameters, skill level, learning rate, physical limitations, etc. The goal model may be constructed and interpreted as a desired body posture, and presented to the trainee, for example, as a second or third human figure, on top of the other figure(s) or separately.

The movement task may include, for example, any set of maneuvers in an order they should be learnt. The task selection may be programmed off-line before the training, while the transition from the current task to the next one may be done upon reaching a certain performance criteria.

First, as shown at 107, a motion error is calculated as the difference between a motion pre-defined in a task and the motion from the estimated model calculated from measurements (linear and angular velocities)

Then, as shown at 108, the desired forces and moments are calculated from the motion error, using control algorithms; and, as shown at 109, a difference of forces and moments is calculated, between desired forces and moments computed by a controller and currently estimated forces and moments acting on the trainee's body. This may be done by a controller module 203 (or motion tracking controller 303) of computer 200, using the predicted model.

In the example of skydiving, the input and the output of the motion tracking controller (303) include 6 dimensions (3 forces and 3 moments). Therefore, the structure of the controller may be designed in several ways:
Six independent controllers each has a scalar input and output, formulated as a proportional integrator (PI) or proportional integrator derivative (PID).
Two independent controllers: one for longitudinal and one for lateral motion tracking, each has input and output with 3 dimensions, formulated as a classical multi-input multi-output (MIMO) controller.
One MIMO controller with 6 dimensions.

The controller may be switched during training from one configuration to another: when the system operates in the proximity of an equilibrium position and thus may be conveniently linearly modeled (and/or decoupled into longitudinal and lateral planes) it may be advantageous to switch to MIMO control. When the system is unstable, performing large-scale movements, far from all of its equilibrium states, it may be more appropriate to switch the controller to the first (independent) structure.

Optionally, a two-input two-output (TITO) controller is used. This may be done for when, for some tasks, the general interface (of 3 dimensional force and moment, described above) between the controller and the learning module, which is described below, might not be needed. For example, when the learning module treats body postures in terms of parameterized combinations of certain joints rotation sequences, then the controller output may be the desired values for those parameters. The goal position then follows from substituting the desired parameters into the relevant degrees-of-freedom defined by the specific joints. For example, a decentralized controller may be designed that is able to track linear and angular velocity commands by the means of only two inputs to a non-linear skydiver plant: first associated with bending the legs (leg pattern), and second with deflecting the arms (arm pattern).

Then, as shown at 110, a goal model of the body in a desired position is constructed from the calculated difference using learning algorithms. This may be done by a learning module 204 (or biomechanical module 304) of computer 200. The goal model is then presented on visual output device 230, as described above and shown at 106.

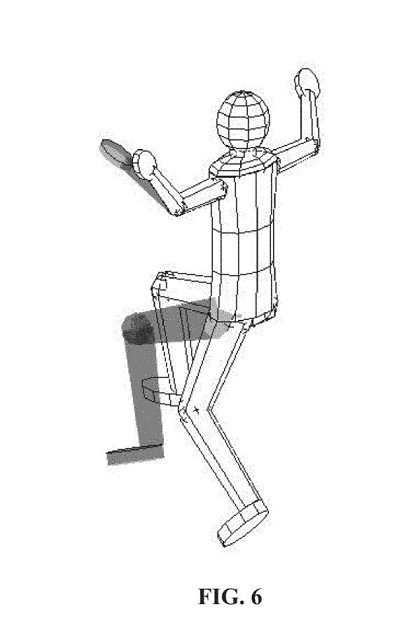

Learning module 204 provides the desired body configuration for the augmented display, by exploring outcomes given possible movement patterns and selecting the best one. The origin (the pelvis joint) of the ‘desired’ body figure should coincide with the origin of the ‘predicted’ figure, such that the difference in the configuration between the two figures becomes immediately apparent to the viewer. The ‘desired’ figure may be made partially transparent, as shown on FIG. 6, which is a schematic illustration of a displayed predicted and desired figures, according to some embodiments of the present invention.

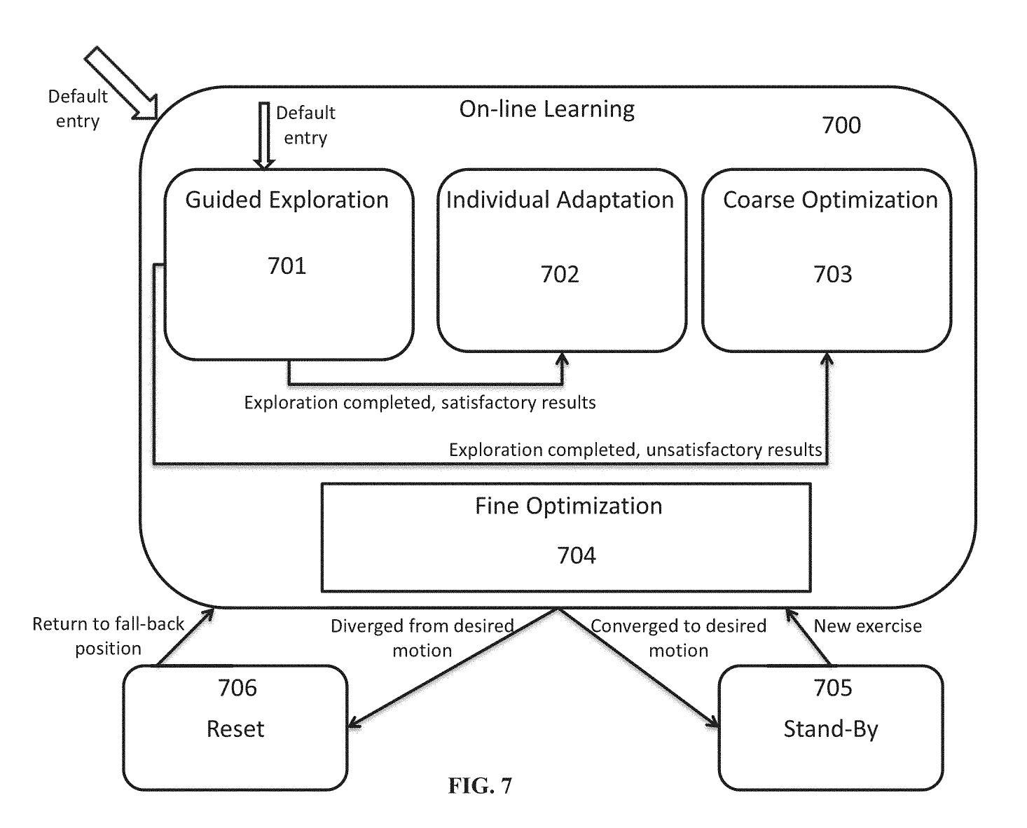

Optionally, the internal structure of learning module 204 may be a state-machine that includes different schemes, such as optimization, guided exploration, and individual adaptation, to select an action for creating the goal model. Reference is made to FIG. 7, which is a schematic illustration of a state-machine of a learning module (On-line learning 700), according to some embodiments of the present invention.

Guided Exploration (701)

Optionally, the difference is classified according magnitude, direction and/or type; an action is selected from an action pool to create the goal model, optionally based on based on a Q-learning look-up table and/or a guidance strategy for selecting unevaluated actions, and the action is evaluated based on its efficiency in minimizing a newly calculated difference between the desired and current forces and moments and/or in minimizing a newly calculated error between the measured movement and the movement task.

The default entry to the learning module's state-machine is into the Guided Exploration state. This state, as well as the Individual Adaptation state, is acting as an on-line learning algorithm, such as Q-learning (or other TD (Temporal Difference) algorithm). While the module remains in the Guided Exploration state, the following actions are performed at each computation step:

1. Error Classification: the discrepancy between the predicted forces/moments and the desired forces/moments (computed by the Motion Tracking Controller) is classified into a number of discrete states. Examples of such states may be: ‘big negative difference in force x-component’, ‘small positive difference in moment y-component’, ‘big differences in all forces and moments’, etc. The total number of states may range, for example, from 13-15 to few hundreds. When the number of states is minimal, the classification proceeds according to the largest and most dangerous discrepancy. For example, when there is one moment component and two force components with large discrepancies, this case may be classified as ‘big negative difference in moment z-component’. In skydiving, moment errors are generally more dangerous than force errors, force errors are more dangerous in directions perpendicular to the gravity vector.

2. Guidance Strategy: one of the actions from an action pool is chosen based on the current state, Q-learning look-up table (containing the cumulative discounted reward of taking actions from the action-pool while being in each one of the states), and the guidance strategy. The action-pool may be constructed off-line and it should contain actions based on utilization of each one of the major body's degrees-of-freedom. It may also contain combinations (of certain joints rotations) describing the patterns that work good for fixing various undesirable motions (or initiating desirable moves). These movement patterns may be extracted from a vast empirical knowledge of practicing skydivers and from off-line simulations of the Forward Model. Based on this theoretical and empirical knowledge the Q-learning look-up table is initially filled in off-line. The guidance strategy aims to guide a skydiver through all potentially helpful movement patterns that may be tried for resolving the currently experienced forces/moments discrepancies. Thus, given the current motion state, the action-pool is inspected and one of the actions that has not been yet evaluated is chosen, starting from more perspective ones (higher scored off-line). The guidance strategy is also responsible for maintaining each action during sufficient time (such that its effect is clearly observed), and for a sufficient number of independent experiments (to make statistical conclusions of its effect, i.e. to ensure the Q-learning convergence). Thus, a convergence indicator should be maintained for each entry of the Q-learning look-up table.

3. Evaluation Function Update: the Q-learning look-up table is updated according to the Q-value of the previous state-action pair, the Q-value of the action chosen at the current step, the discount-factor, learning-rate and reward-function. The learning-rate and discount-factor parameters may be tuned on-line or set to constant values, reasonably chosen. The reward-function may get a positive value proportional to how fast the skydiver's motion states (linear and angular velocity) converge to desired values, and a negative value in the case of divergence.

Fine Optimization (704)

Optionally, multiple suggested action optimizations are tested using cost function calculated on Monte-Carlo simulations results, and a selected action optimization is used for updating said goal model.

Once the action is chosen from the action-pool, the Fine Optimization function is executed. The Fine Optimization is needed because the chosen action contains only an approximate—‘coarse’ movement pattern, which is taken from a limited discrete action-pool and doesn't resolve all 6 components of forces/moments discrepancies, but only contains a basic idea of needed action. The Fine Optimization has two stages:

1. Monte-Carlo Simulations: a number (from few tens to few hundreds) of simulations of the Forward Model are run with different movement patterns (combinations of joints rotation rates). The movement patterns are generated by adding small random deviations from a coarse movement pattern chosen from the action-pool. The results (outputs of the Forward Model) of each run are stored for further processing.

2. Performing Optimization: at this step an optimal movement pattern is chosen out of the simulated ones. First of all, all patterns that bring the forces and moments discrepancies to small values (below a desired threshold) are considered. Next, each pattern is evaluated according to a cost function that may include (but is not limited to) the following criteria:

A. Proximity of the predicted body configuration (dictated by this movement pattern) to the current body configuration;

B. Proximity of the joints rates (that define this pattern) to the current joints rates;

C. Symmetry of the predicted body configuration;

D. Proximity of the predicted motion (linear and angular velocities) to the defined by the current task;

E. Displacement of the body from the current inertial position;

F. Proximity of the predicted body configuration to one of the equilibrium configurations expected for the current task. (A pool of typical equilibrium configurations for all tasks is constructed off-line from experimental and theoretical knowledge, together with the actions-pool).

A pattern that minimizes the cost function is chosen and the body configuration that emerges from this pattern is outputted to the augmented display.

Individual Adaptation (702)

Optionally, selecting an action is based on previous efficiency results of the actions, by selecting the most efficient action. The results may be global for multiple trainees or specific for an individual trainee.

Initially, when a skydiver starts using the KTM, the learning module is constantly in the state of Guided Exploration, encouraging the trainee to try out all the movement patterns known to work. At a later stage, after all relevant actions in the action-pool are reliably evaluated for the current state and one or more actions has received a satisfactory score, the transition to the Individual Adaptation state occurs. This state includes the same computation steps as the Guided Exploration, except that during choosing the action from action-pool the aim is different: instead of exploring the possibilities the aim is to choose the best one (from the evaluated so far). The Action Policy may be chosen typically for a Q-learning algorithm, for example e-greedy: choosing action that has a maximum value in the Q-learning look-up table in the column of the current state.

The transition to Individual Adaptation may happen before all of the possible actions have been evaluated, under condition that at least one efficient enough action has been found. This way it would be possible to keep an optimal balance between learning new ways to move and practicing the movements that worked well before. This balance may be different for each individual skydiver, and, therefore, may be tuned on-line. The update of the Q-learning look-up table and its convergence is not compromised by using different action policies (Guided Exploration, Individual Adaptation, Random Search (described in the next section)) since Q-learning is an off-policy method.

After an action is chosen from the action-pool, the Fine Optimization is executed.

Coarse Optimization (703)

Optionally, actions are added to the action-pool by performing Monte-Carlo simulations on randomly generated actions and selecting the best ones.

In case that all actions in the action-pool have been reliably evaluated but none of the actions have been found efficient enough, it is possible to find a new action and add it to the action-pool. In this case the state-machine is in the Coarse Optimization state. The new action is created by the means of Monte-Carlo simulations, similar to the Fine Optimization simulation runs. The only difference is in the generation of movement patterns: instead of perturbing a pre-defined pattern, the patterns are generated completely randomly using the whole available range of all joints rotations.

Once a movement pattern that minimizes the cost function is chosen, the Fine Optimization is executed.

Stand-by State (705) and Reset State (706)

Optionally, the trainee's success or failure in performing the task is evaluated, and the next task or a default fall-back maneuver is selected and activated.

The state-machine of the Learning module is executing an On-Line Learning state until the task is either completed or failed. In those cases transitions to Stand-By and Reset states occurs. In both cases a switch to a new task is initiated:

1. Switching to the next task from the tasks protocol (constructed offline). When the desired motion (linear and angular velocity defined by the task) is maintained by a skydiver with a sufficient accuracy for a sufficient amount of time, and there is still enough free-fall time remaining for another exercise, the new task is triggered. In case a skydiver is running out of free-fall time, the state-machine remains in the Stand-By state. In case a new task is triggered, one additional cue may be displayed (during the first few seconds of task execution) in order to indicate to a skydiver that the task has changed. This additional cue may be a figure of a skydiver in an equilibrium configuration positioned and orientated in a way indicative to the task. For example, when the new task is to move backwards—the additional figure may be positioned behind the ‘predicted’ and ‘desired’ figures at a distance proportional to the desired backwards moving speed.

2. Switching to the fall-back maneuver. Each skydiving maneuver is based on a previously mastered (less complex) maneuver that may be used as a fall-back in case that learning of a new maneuver fails. Failure of the task may be defined as loosing stability for a long enough time and developing growing (diverging) linear/angular velocities. In this case, the KTM might switch off for a few seconds and, when there is enough free-fall time remaining, switch back on with a fall-back task.

Optionally, recommended movement instructions based on the goal model are presented on visual output device 230. For example, the instructions may include visual cues presented on top of the presented human figure to indicated suggested movements and/or may be written as text

Optionally, other cues may be activated, for example, voice instructions and/or using haptic devices (such as vibrotactile bracelets). These cues may be used as additional cues that enhance the visual cues.

The following are exemplary scenarios of using the system according to some embodiments of the present invention (KTM) by a skydiving trainee.

In a first exemplary scenario, a fast learner skydiving trainee is learning slow-fall in a belly-to-earth position. A pre-requirement for learning slow-fall is maintaining a stable belly-to-earth position with a constant fall-rate (i.e. angular velocity and horizontal components of linear velocity are zero, vertical component of linear velocity is constant and its value is typical to a default equilibrium configuration of this skydiver). This may also be a fall-back exercise. Slow-fall means altering the vertical speed to a lower than a default (current) value. This is achieved by altering the body configuration.

First, the skydiver exits an airplane and gets stable into a default belly-to-earth position. The KTM switches on the display and indicates the beginning of the exercise by displaying a body figure in a typical slow-fall configuration positioned slightly above the ‘predicted’ figure. The displayed background objects are continuously moving in a vertical direction at a constant (default) pace.

Then, the skydiver alters his body configuration, initiating a desirable vertical deceleration and an undesirable angular velocity about a vertical axis. The Motion Tracking Controller of the KTM produces a small negative vertical force command and a significant yaw torque command (in the opposite direction to the measured spin and the predicted by the Forward Model yaw moment). The Learning module classifies this situation as a ‘big negative difference in moment z-component’ state, and the Guided Exploration chooses the action that in theory best fixes this error: ‘rotate the left shoulder downwards’. The Fine Optimization finds a movement pattern that includes rotating the left shoulder and also bending the pelvis some more (to account for the error in force z-component). The desired configuration is shown on the augmented display along with the predicted configuration, and the background objects that start to move slower in a vertical direction and at the same time rotate opposite to the measured yaw rate.

Then, when the skydiver keeps adjusting his body configuration according to the displayed cues, the undesirable spin slows down and then comes to a stop. The state classification inside the Learning module goes to ‘small negative difference in moment z-component’ and thus ‘move towards symmetrical configuration’ action is chosen (it is known from experience that all small errors are best resolved by just relying on a natural body symmetry). The predicted body configuration becomes closer and closer to the desired body configuration. The measured inertial velocities are close enough to the desired ones (within a predefined threshold).

Finally, the state machine transitions to stand-by, initiates a return to fall-back position, and then starts the slow-fall exercise over again. Next time the undesirable spin happens, the Guided Exploration advises a different action to fix it. After a few repetitions the skydiver transitions into slow-fall without any undesirable side-effects. In a second exemplary scenario, a slow learner skydiving trainee is learning slow-fall in a belly-to-earth position.

First, the skydiver exits an airplane and gets into a default belly-to-earth position, while experiencing back-sliding (negative linear velocity component along the spinal column) without knowing it, due to extending the arms too far forward. The KTM switches on the display and registers the discrepancy between the measured motion and the pre-required motion for initializing the planned exercise. The ‘reset’ state is engaged and the exercise is set to the ‘fall-back’ one. The Guided Exploration chooses ‘extend legs’ action, since in theory it is best for fixing back-slide. The Fine Optimization converges to a pattern that includes both extending the legs and bringing-in the arms, because it provides a configuration closest to the default equilibrium one. The desired configuration is shown on the augmented display along with the predicted configuration, and the background objects that move in a vertical direction and forwards.

Then, the skydiver adjusts his body configuration and the back-slide slowly stops. At some point the KTM indicates the beginning of the slow-fall exercise (by displaying a body figure in a typical slow-fall configuration positioned slightly above the ‘predicted’ figure). The skydiver attempts the displayed configuration and looses stability: flips back-to-earth while spinning and sliding. (This often happens during the first attempt of slow-fall, since this is an unstable equilibrium position). The KTM engages the ‘reset’ state and replaces the ‘desired’ configuration on the display by the default stable configuration of the ‘fall-back’ exercise (positioned and oriented the same way as the ‘predicted’ figure, so that the difference in body configuration becomes immediately apparent). The background objects are moved accordingly (to convey the inertial motion of the skydiver).

Finally, the skydiver regains stability close to the opening altitude. The KTM calculates the remaining free-fall time, finds it not sufficient for re-starting the slow-fall exercise and switches off.

In a third exemplary scenario, an advanced learner skydiving trainee is learning forward motion in a sit-fly position. A pre-requirement for learning sit-fly is full control of all basic maneuvers in belly-to-earth and back-to-earth orientations. A fall-back of sit-fly is a default back-to-earth position, and a fall-back of back-flying is flying belly-to-earth. The following scenario may be typical for a skydiver who has been previously using the KTM while belly and back flying, such that the KTM's learning module has fully evaluated all relevant actions for most of the errors that happen during belly and back flying. This means that during fall-backs the learning module is in the Individual Adaptation state and advises patterns that have worked best for this skydiver before. While the module is in the Guided Exploration state (while learning to sit-fly) it may first try motion patterns engaging the same degrees-of-freedom that proved to be most efficient for solving similar errors in belly/back orientations.

First, the skydiver exits the airplane in a back-to-earth position, immediately the KTM is switched on and the learning module classifies the current state as ‘normal exit on the back’. The Guided Exploration chooses action ‘roll head backwards’, because from experience of other skydivers this action helps to bring the body into an up-right orientation. The Fine Optimization adds to this basic action some adjustments to legs' positions, and the finalized ‘desired’ configuration is shown on the augmented display, along with ‘predicted’ configuration and moving background objects (in the beginning mainly in the direction opposite to the flight direction of the airplane, slowly gaining speed in the vertical direction).

Then, the skydiver alters the head position and flips from back-to-earth into a sit orientation. As this happens, the pitch moment error (the difference between the pitch moment computed by the Motion Tracking Controller and predicted by the Forward Model) switches its sign, and the learning module slowly returns the head of the ‘desired’ configuration to its normal position (aligned with the body).

Then, the skydiver stabilizes in a default sit-fly position, and the KTM initiates the beginning of the exercise by displaying a body figure leaning backwards (a configuration typically used for flying forward) positioned slightly in front of the ‘predicted’ figure. The Guided Exploration classifies this situation as ‘big negative difference in force x-component’ and chooses a combined action: ‘lean backwards’ and ‘straighten the legs’, because this skydiver's Q-learning look-up table contains very high scores for all actions involving shins' movement. This pattern is finalized (by the Fine Optimization) and the resulting ‘desired’ configuration is displayed (with the same origin and orientation as the ‘predicted’ one).

Then, the skydiver succeeds to move forward for a couple of seconds, but then looses stability and starts rolling backwards and spinning. The KTM transitions to the ‘reset’ state and initiates a roll-back exercise: stable back-fly. The skydiver keeps spinning in a back-to-earth orientation (due to uneven tension in the muscles as a result of a stress). The Individual Adaptation chooses a policy with the highest score from the Q-learning look-up table for the state ‘big negative difference in moment z-component—back-fly’. After the ‘desired’ configuration is finalized and displayed, the skydiver slowly manages to stop the spin. During this process the Fine Optimization at each computation step brings the resulting configuration closer and closer to the default stable back-fly equilibrium configuration. (This happens because the Individual Adaptation selects smaller amplitude movements as the error in the yaw moment becomes smaller, and perturbing more gentle movement patterns converges to configurations closer to the default symmetric one. This happens automatically since the initial highly unsymmetrical move that was required to stop the spin is slowly cancelled out (limbs are guided towards a symmetrical configuration) as other movements are added to the desired pattern to compensate for any undesirable motions).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems for training motor skill will be developed and the scope of the term motor skill training is intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of motor skill training using visual computer generated feedback, comprising:
receiving from a plurality of sensors measurements of a current position and motion of a trainee's body;
constructing an estimated model of said body in said current position and motion based on said measurements and on specific characteristics of said body;
calculating a predicted model of said body in an estimated future state based on said estimated model; and
presenting said predicted model to said trainee on a visual output device.

2. The method of claim 1, further comprising:
constructing a goal model of said body in a pre-defined desired position and orientation; and
presenting said goal model on said visual output device, to guide said trainee in performing movements so that said predicted model is similar to said goal model.

3. The method of claim 1, further comprising:
calculating a motion error between a pre-defined movement task and movement from said estimated model;
calculating desired forces and moments from said motion error using control algorithms;
calculating a difference between said desired forces and moments and currently estimated forces and moments acting on said trainee's body;
constructing a goal model of said body in a desired position from said difference using learning algorithms; and
presenting said goal model on said visual output device, to guide said trainee in performing movements so that said predicted model is similar to said goal model.

4. The method of claim 3, wherein said constructing is done by a state machine of schemes to select an action for creating said goal model.

5. The method of claim 3, wherein said learning algorithms includes:
classifying said difference according to at least one of magnitude, direction and type;
selecting one of a plurality of actions based on said classification;
creating said goal model from said selected action; and
evaluating efficiency of said selected action.

6. The method of claim 5, wherein said evaluating is done according to a new calculated difference between said desired forces and moments and current forces and moments acting on said trainee's body.

7. The method of claim 5, wherein said evaluating is done according to a new calculated error between a measured movement and said pre-defined movement task.

8. The method of claim 5, wherein said selecting is also based on a Q-learning look-up table and said evaluating includes updating said look-up table.

9. The method of claim 5, wherein said selecting is also based on a guidance strategy for selecting unevaluated actions.

10. The method of claim 5, wherein said selecting is also based on previously evaluated efficiency of said plurality of actions.

11. The method of claim 5, wherein said learning algorithms further includes:
performing Monte-Carlo simulations of a plurality of suggested action optimizations;
selecting one of said plurality of action optimizations based on a cost function calculated on said simulations; and
updating said selected action according to said selected action optimization.

12. The method of claim 5, wherein said learning algorithms further includes:
performing Monte-Carlo simulations of a plurality of randomly generated actions;
selecting at least one of said randomly generated actions based on a cost function calculated on said simulations; and
adding said selected at least one action to said plurality of actions.

13. The method of claim 3, further comprising:
presenting on said visual output device recommended movement instructions based on said predicted model, said goal model and said specific characteristics.

14. The method of claim 3, further comprising:
evaluating success of said trainee in performing said pre-defined movement task; and
activating a second pre-defined movement task based on said success.

15. The method of claim 3, further comprising:
detecting failure of said trainee in performing said pre-defined movement task; and
activating a default pre-defined movement task.

16. The method of claim 1, further comprising:
presenting on said visual output device background elements relative to said predicted model.

17. The method of claim 1, wherein said trainee is a skydiving trainee.

18. The method of claim 1, wherein said visual output device is an augmented reality head device.

19. A computer readable medium comprising computer executable instructions adapted to perform the method of claim 1.

20. A system of motor skill training using visual computer generated feedback, comprising:
a plurality of sensors for acquiring measurements of a current position and motion of a trainee's body;
at least one computerized processor for:
constructing an estimated model of said body in said current position and motion based on said measurements and on specific characteristics of said body; and
calculating a predicted model of said body in an estimated future state based on said estimated model; and
a visual output device for presenting said predicted model to said trainee.

21. A software program product for automatically cross-referencing error information between code developers, comprising:
a non-transitory computer readable storage medium;
first program instructions for receiving from a plurality of sensors measurements of a current position and motion of a trainee's body;
second program instructions for constructing an estimated model of said body in said current position and motion based on said measurements and on specific characteristics of said body;
third program instructions for calculating a predicted model of said body in an estimated future state based on said estimated model; and
fourth program instructions for presenting said predicted model to said trainee on a visual output device;
wherein said first, second, third and fourth program instructions are executed by at least one computerized processor from said non-transitory computer readable storage medium.
